(19) United States
(12) Patent Application Publication
(10) Pub. No.: US 2018/0191269 A1
(43) Pub. Date: Jul. 5, 2018

(54) PARALLEL-STACKED MINI INVERTER FOR CONTINUOUS HIGH EFFICIENCY LOW-POWER OUTPUT DURING MAIN INVERTER SLEEP MODE

(71) Applicant: Parker-Hannifin Corporation, Cleveland, OH (US)

(72) Inventor: Steven Robert Knight, Killingworth, CT (US)

(73) Assignee: Parker-Hannifin Corporation, Cleveland, OH (US)

(21) Appl. No.: 15/739,185

(22) PCT Filed: Jun. 20, 2016
(86) PCT No.: PCT/US2016/038295

§ 371 Date: Dec. 22, 2017

Related U.S. Application Data
(60) Provisional application No. 62/187,953, filed on Jul. 2, 2015.

(51) Int. Cl. H02M 7/44; H02J 7/00; B60R 16/03

(52) U.S. Cl. CPC H02M 7/44; H02M 2001/0048; B60R 16/03; H02J 7/0065

(57) ABSTRACT

A power converter for converting direct current (DC) power to alternating current (AC) power includes a first power converter section and a second power converter section connected in parallel with the first power converter section. A power rating of the first power converter section is substantially greater than a power rating of the second power converter section. A controller is operatively coupled to the first power converter section and the second power converter section, the controller configured to enable at least the first power controller section when a power demand placed on the power converter exceeds a prescribed power level, and disable the first power controller and enable the second power controller section when the power demand placed on the power converter is below the prescribed power level. An advantage of the power converter in accordance with the present disclosure is that it minimizes parasitic losses associated with larger power sections of the converter.

### RELATED APPLICATION DATA

The present application claims the benefit of the filing date of U.S. Provisional Patent Application Ser. No. 62/187,953 filed Jul. 2, 2015, which is incorporated herein by reference in its entirety.

### TECHNICAL FIELD

This present disclosure relates generally to power converters for converting direct current power to alternating current power and, more particularly, to a power converter that efficiently provides such power during both low demand and high demand conditions.

### BACKGROUND OF THE INVENTION

It is often desirable to convert a DC voltage from a battery into a 110 volt AC. Power converters that perform such functions are generally termed voltage inverters, and most often are designed to operate from a 12 volt automobile battery to produce alternating current, for example to power television sets or microwave ovens in recreational vehicles. Such inverters are also extremely useful as backup power sources for electrical office equipment, electronic cash registers, minicomputers and even sump pumps.

### SUMMARY OF THE INVENTION

Power converters, such as inverters, are offered in various power ratings. During operation, power converters consume a certain amount of power, even when very little power is being consumed by other devices. A factor that contributes to the power consumed by power converters during idle time is their power rating, where larger-rated power converters consume more power than lower-rated power converters. This difference is generally due to losses in the larger semiconductor devices employed to obtain the higher power rating.

In recreational vehicles and other applications it is desirable to have power available at outlets at all times to provide convenience, for example, to charge batteries of small electronic devices such as mobile phones and tablet computers. The power converters that supply such outlets are typically rated to provide power for other devices, such as microwaves, hair dryers, etc. that may be found in a recreational vehicle. Many times, however, such “other” devices are not used for the vast majority of the day due to their intermittent use or during sleeping hours. Thus, during periods of low demand significant power may be consumed by the power converter, thereby unnecessarily reducing battery life.

A power converter in accordance with the present disclosure includes a primary power converter section that provides power at a first power rating, and a secondary power converter section that provides power at second power rating that is substantially lower than the first power rating. The primary and secondary power converter sections are electrically connected to one another in a parallel configuration with their output frequencies synchronized and thus can provide power in tandem or individually. When power demand exceeds a prescribed power level, power is provided by the primary power converter section and, if needed, the secondary power converter section may augment the power provided by the primary power converter section. When power drops below the prescribed power level, the primary power converter section is placed in a low power state (e.g., sleep mode) and power is provided by only the secondary power converter section. Due to the secondary power converter section being substantially smaller in power output capability relative to the primary power converter section, the secondary power converter section's power electronics experiences less power loss and thus can efficiently provide power at low demand levels. In this manner, power can be maintained at outlets while minimizing power drain on the batteries.

According to one aspect of the present disclosure, a power converter for converting direct current (DC) power to alternating current (AC) power includes: a first power converter section; and a second power converter section connected in parallel with the first power converter section, wherein a power rating of the first power converter section is substantially greater than a power rating of the second power converter section.

In one embodiment, the power converter includes a controller operatively coupled to the first power converter section and the second power converter section, the controller configured to activate the first power converter section when a power demand placed on the power converter exceeds a prescribed power level, and deactivate the first power converter section when the power demand placed on the power converter is below the prescribed power level.

In one embodiment, the controller is configured to deactivate the second power converter section when the first power converter section is activated, and activate the second power converter section when the first power converter section is deactivated.

In one embodiment, the power converter includes: an output terminal for providing power out of the power converter; and a switch electrically connected in series between the first power converter section and the output terminal, wherein the controller is configured to open the switch when power demand on the power converter is below a prescribed power level.

In one embodiment, the power rating of the first power converter section is at least ten times a power rating of the second power converter section.

In one embodiment, the power converter includes an input terminal for receiving DC power, wherein an input of the first power converter section and an input of the second power converter section are electrically connected to the input terminal.

In one embodiment, the first and second power converter sections each comprise an inverter.

In one embodiment, the first power converter section and the second power converter section are formed as an integral unit.

According to another aspect of the present disclosure, a power system includes a direct current (DC) power source, and a power converter as described herein.

In one embodiment, the power system includes at least one of an electrical outlet or an electrical appliance electrically connected to the power converter.

In one embodiment, the DC power source comprises a battery.

According to another aspect of the present disclosure, a method for providing alternating current (AC) power to a load using a direct current (DC) source includes: monitoring a power demand of the load; using a first converter section having a first power output rating to convert the DC power to AC power when the power demand exceeds a prescribed level; and using a second converter section having a second power output rating to convert the DC power to AC power when the power demand is less than the prescribed level, wherein the first power rating is substantially greater than the second power rating.

In one embodiment, the method includes using both the first and second power converter sections to convert the DC power to AC power when the power demand is greater than the prescribed level.

In one embodiment, the method includes using only the second power converter section to convert the DC power to AC power when the power demand is less than the prescribed level.

In one embodiment, the first power rating is at least ten times the second power rating.

In one embodiment, using first and second power converter sections comprises using first and second inverters as the first and second power converter sections.

In one embodiment, converting DC power to AC power includes using a battery to supply the DC power.

In one embodiment, the method includes providing the AC power to at least one of an electrical outlet or an electrical appliance electrically connected to the power converter.

These and other features of the invention are more fully described and particularly pointed out in the description and claims set out below, and this Summary is not intended to identify key features or essential features of the claimed subject matter. The following description and claims and the annexed drawings set forth in detail certain illustrative embodiments of the invention, and these embodiments indicate but a few of the various ways in which the principles of the invention may be used.

### BRIEF DESCRIPTION OF THE DRAWINGS

Embodiments of this invention will now be described in further detail with reference to the accompanying drawings.

FIG. 1 is a block diagram of an exemplary recreational vehicle in which the power converter in accordance with the present disclosure may be employed.

FIG. 2 is a schematic diagram of a power converter in accordance with the present disclosure.

FIG. 3 is a flow chart illustrating an exemplary method in accordance with the present disclosure.

### DETAILED DESCRIPTION OF THE DRAWINGS

Recreational vehicles such as campers, motor homes, boats, etc., include power converters that convert direct current (DC) power to alternating current (AC) power. The AC power is distributed throughout the recreational vehicle to convenience outlets, appliances, etc. to power such devices.

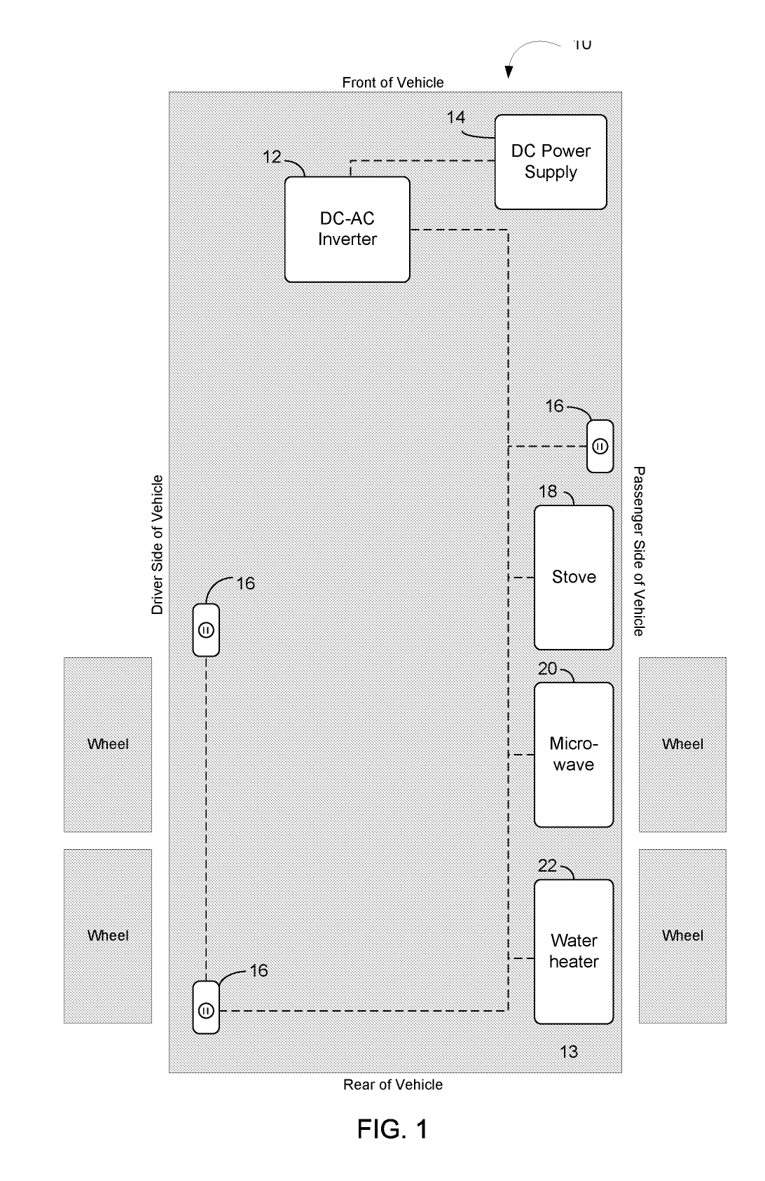

FIG. 1 illustrates an exemplary recreational vehicle 10, e.g., a trailer, which includes a power converter 12 for converting DC power to AC power. An input of the power converter 12 is electrically connected to a DC power source 14, such as one or more 12-volt batteries in the present example. Twelve volts DC is a voltage that is typically found in modern vehicles, such as cars, trucks, boats, etc. and thus the power converter is described as having a DC source formed from 12-volt batteries. It should be appreciated, however, that other voltages and/or devices may be used to provide DC power to the power converter without departing from the scope of the invention (e.g., the DC source may be formed from one or more 6-volt batteries).

An output of the power converter 12 is electrically connected to one or more convenience outlets 16, oven 18, microwave oven 20, hot water heater 22, or any other electrically operated device that may be utilized in the recreational vehicle. The power converter 12 is sized to provide sufficient power for the expected load. Thus, in a recreational vehicle 12 that includes an oven 18, microwave oven 20, a hot water heater 22, as well as convenience outlets 16 (which may be used to power one or more television sets, satellite receivers, etc.), the power converter 12 may be sized to provide 3000 watts of power or more. Many times, however, the full rated power is not needed and the power converter 12 is active but effectively providing only a fraction of its rated power output. While the power converter 12 may be providing minimal power it still consumes a minimum amount of power, much of which is due to inefficiencies in the power electronics section of the power converter 12. The “power electronics section” refers to electronic devices that convert the DC waveform to an AC waveform, such as high power semiconductor devices (e.g., transistors, diodes or the like) and if present the transformer utilized to step the voltage to the desired level. A factor in the minimum power consumed by power converters is the power rating of the power converter section (power electronics section), where higher-rated power converter sections consume more power than lower-rated power converter sections. This difference in power consumption is generally due to losses in the larger semiconductor devices employed in the higher-rated power converter sections.

To minimize battery drain when major appliances are not in use, the power converter 12 may simply be turned off. However, this can create an inconvenience as the outlets 16, which are often used to charge batteries or power small electronic devices (e.g., routers, clocks), become inoperative.

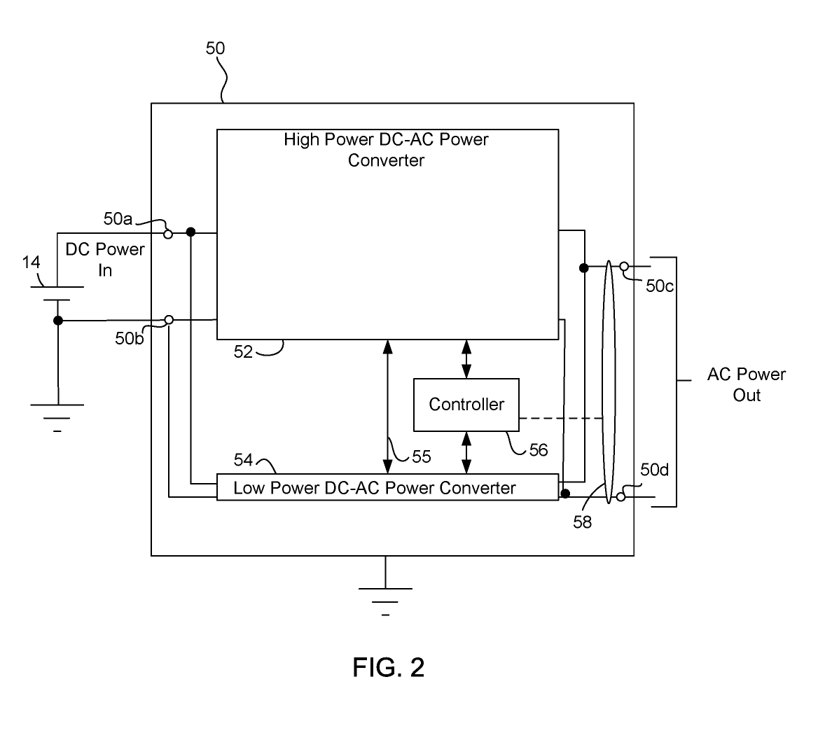

With reference to FIG. 2, a power converter 50 in accordance with the present disclosure includes input terminals 50a and 50b for receiving DC power from a DC power source, such as battery 14, and output power terminals 50c and 50d for providing AC power to other devices. The power converter 50 further includes a first power converter section 52 and a second power converter section 54 connected in parallel with the first power converter section 52. For example, inputs of the first power converter section 52 and inputs of the second power converter section 54 are electrically connected to input terminals 50a and 50b of the power converter 50. Further, outputs of the first power converter section 52 and outputs of the second power converter section 54 are electrically connected to output terminals 50c and 50d of the power converter 50. A communication device 55 (e.g., a cable or the like) communicatively couples the first power converter section 52 to the second power converter section 54. The communication device 55 may be used to exchange data between the respective converter sections, such as during an output synchronization process. Preferably, the power converter 50 is configured as an integral unit, where both the first power converter section 52 and the second power converter section 54 are housed within a common enclosure.

In one embodiment, the first and second power converter sections 52 and 54 are inverters that convert DC voltage to AC voltage. As is known, in conventional inverters DC power is connected to a transformer through a center tap of the transformer primary winding. A switch (e.g., a transistor switch) is rapidly switched back and forth to allow current to flow back to the DC source following two alternate paths through one end of the primary winding and then the other end of the primary winding. The alternation of the direction of current in the primary winding of the transformer produces alternating current in the secondary circuit.

In accordance with the present disclosure, a power rating of the first power converter section 52 is substantially greater than a power rating of the second power converter section 54. As used herein, the first power converter section 52 having a power rating that is “substantially greater” that a power rating of the second power converter section 54 means the power rating of the first power converter section 52 is at least five times the power rating of the second power converter section 54. In one embodiment, the power rating of the first power converter section 52 is at least ten times the power rating of the second power converter section 54, and in another embodiment the power rating of the first power converter section 52 is at least thirty times the power rating of the second power converter section).

A controller 56 is operatively coupled to the first power converter section 52 and the second power converter section 54. In one embodiment the controller includes a processor, a memory and instructions stored in the memory and executable by the processor, the instructions operative to cause the processor to control the first and second power converter sections 52 and 54 as described herein. In another embodiment, the controller 56 includes dedicated logic for controlling the first and second power converter sections 52 and 54 as described herein.

The power converter 50 also includes a sensor 58 operative to measure a power load at an output of the power converter 50, and provide the measurement to the controller 56. The sensor 58 may be any type of sensor that can measure a power load placed on the power converter 50. For example, the sensor 58 may include one or more of a current sensor, a voltage sensor, and/or a power sensor. While the sensor 58 is arranged at the output of the power converter, load may also be measured at an input of the power converter 50.

The controller 56 is configured to activate the first power controller section 52 when a power demand placed on the power converter 50 (as measured by the sensor 58) exceeds a prescribed power level, and deactivate the first power converter section 52 when the power demand placed on the power converter 50 is below the prescribed power level. In one embodiment, the prescribed power level is 90 percent of the power rating of the second power converter section 54.

During periods of operation when the load on the power converter 50 is low, e.g., below the prescribed threshold, the first high-power converter section 52 is deactivated and the second low-power converter section 54 is activated. Deactivation of a power converter section means that at least the power electronics of the power converter section are turned off or otherwise disabled, but control electronics of the power converter section may remain active. In one embodiment, the control electronics are part of the power converter section, and in another embodiment the control electronics are part of the controller 56.

In one embodiment, the controller 56 is configured to deactivate the second power converter section 54 when the first power converter section 52 is activated, and activate the second power converter section 54 when the first power converter section 52 is deactivated. In another embodiment, the controller is configured to maintain the second power converter section 54 active at all times, while the first power converter section 52 is activated or deactivated based on the power load on the converter 50.

In activating and/or deactivating the respective power converter sections, the controller 56 is configured to synchronize the output of one power converter section with the output of the other power converter section such that the voltage waveforms output by each section are in-phase. In this manner, a seamless transition from an inactive state to an active state of the first power converter section 52 can be obtained.

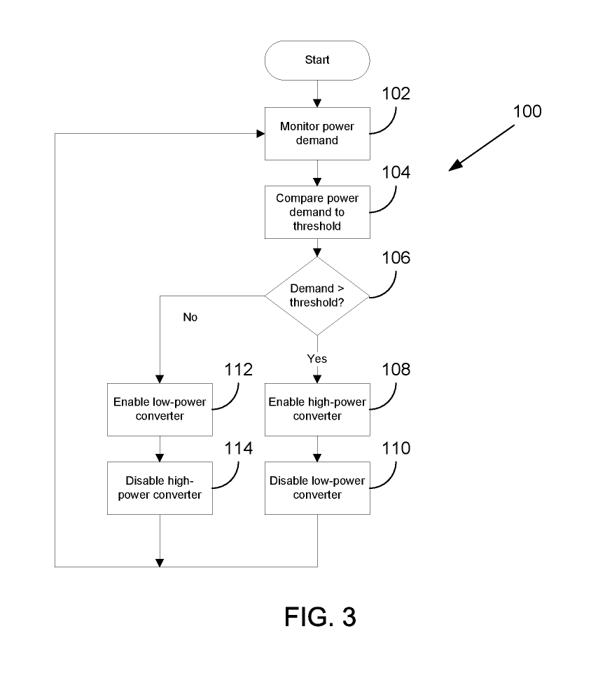

Referring now To FIG. 3, illustrated is a flow chart 100 depicting exemplary steps for providing alternating current (AC) power to a load using a direct current (DC) source in accordance with the present disclosure. The steps may be executed by the controller 56 and may be implemented via executable code stored in memory of the controller 56. Alternatively, at least some of the steps illustrated in FIG. 3 may be implemented in dedicated hardware of the controller 56 (e.g., an application-specific integrated circuit).

Beginning at step 102, the power load placed on the power converter 50 is determined by the controller 56. In this regard, the controller 56 receives measurement data from the sensor 58, the measurements indicative of a load placed on the power converter 50. At step 104, the load placed on the converter 50 is compared to a prescribed threshold level. The prescribed threshold level may be predetermined based on the power rating of the second power converter section 54. For example, if the second power converter section is rated for 100 watts, then the prescribed threshold level may be set at 100 watts. As will be appreciated, the specific threshold level may be set below the power rating of the second power converter section 54 so as to not subject the second power converter section 54 to overload conditions. For example, the prescribed threshold may be set at a percentage of the power rating of the second power converter section 54 (e.g., 90 percent).

At step 106 it is determined if the measured power demand exceeds the prescribed threshold value, for example, by way of a comparison of the two values. If the measured power demand exceeds the threshold value, then additional power is required and the first power converter section 52 is activated as indicated at step 108. Activation may include waking the first power converter section 42 from a low power “sleep mode” to a high power operational mode. In addition to waking the power converter section, activation also includes synchronizing the output of the first power converter section 52 with the output of the second power converter section 54 such that the outputs of both power converter sections are in-phase. Next at step 110, the second power converter section 54 may optionally be de-activated, and the method then moves back to step 102. If it is desired that both the first and second power converter sections be active when the power demand is greater than the prescribed level, then step 110 may be omitted and the second power converter section 54 remains activated.

Moving back to step 106, if the measured power load does not exceed the prescribed threshold, then the power converter 50 can operate in low power mode using only the second power converter section 54. Therefore, the method moves to step 112 where the second power converter section 54, if previously de-activated, is activated and synchronized with the output of the first power converter section 52. Next at step 114, the controller 56 deactivates the first power converter section 52. In this regard, the controller 56 commands the first power converter section 52 to deactivate at least the power electronics of the converter section, thereby eliminating any power drain associated with these components, while retaining power on control portions of the converter. Such deactivation may be understood as placing the first power converter section 52 in a low-power “sleep” mode.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A power converter for converting direct current (DC) power to alternating current (AC) power, comprising:
a first power converter section; and
a second power converter section connected in parallel with the first power converter section, wherein a power rating of the first power converter section is substantially greater than a power rating of the second power converter section.

2. The power converter according to claim 1, further comprising a controller operatively coupled to the first power converter section and the second power converter section, the controller configured to activate the first power converter section when a power demand placed on the power converter exceeds a prescribed power level, and deactivate the first power converter section when the power demand placed on the power converter is below the prescribed power level.

3. The power converter according to claim 2, wherein the controller is configured to deactivate the second power converter section when the first power converter section is activated, and activate the second power converter section when the first power converter section is deactivated.

4. The power converter according to claim 2, further comprising:
an output terminal for providing power out of the power converter; and
a switch electrically connected in series between the first power converter section and the output terminal,
wherein the controller is configured to open the switch when power demand on the power converter is below a prescribed power level.

5. The power converter according to claim 1, wherein the power rating of the first power converter section is at least ten times a power rating of the second power converter section.

6. The power converter according to claim 1, further comprising an input terminal for receiving DC power, wherein an input of the first power converter section and an input of the second power converter section are electrically connected to the input terminal.

7. The power converter according to claim 1, wherein the first and second power converter sections each comprise an inverter.

8. The power converter according to claim 1, wherein the first power converter section and the second power converter section are formed as an integral unit.

9. A power system, comprising:
a direct current (DC) power source; and
the power converter according to claim 1.

10. The system according to claim 9, further comprising at least one of an electrical outlet or an electrical appliance electrically connected to the power converter.

11. The system according to claim 9, wherein the DC power source comprises a battery.

12. A method for providing alternating current (AC) power to a load using a direct current (DC) source, the method comprising:
monitoring a power demand of the load;
using a first converter section having a first power output rating to convert the DC power to AC power when the power demand exceeds a prescribed level; and
using a second converter section having a second power output rating to convert the DC power to AC power when the power demand is less than the prescribed level,
wherein the first power rating is substantially greater than the second power rating.

13. The method according to claim 12, further comprising using both the first and second power converter sections to convert the DC power to AC power when the power demand is greater than the prescribed level.

14. The method according to claim 12, further comprising using only the second power converter section to convert the DC power to AC power when the power demand is less than the prescribed level.

15. The method according to claim 12, wherein the first power rating is at least ten times the second power rating.

16. The power converter according to claim 12, wherein using first and second power converter sections comprises using first and second inverters as the first and second power converter sections.

17. The method according to claim 12, wherein converting DC power to AC power includes using a battery to supply the DC power.

18. The method according to claim 12, further comprising providing the AC power to at least one of an electrical outlet or an electrical appliance electrically connected to the power converter.
